(19) United States
(12) Patent Application Publication
(10) Pub. No.: US 2021/0070942 A1
(43) Pub. Date: Mar. 11, 2021

(54) ELASTOMERIC TERPOLYMERS WITH A HIGH SULFUR CONTENT AND PROCESS FOR THEIR PREPARATION

(71) Applicants: ENI S.P.A., Roma (IT); CONSIGLIO NAZIONALE DELLE RICERCHE, Roma (IT)

(72) Inventors: Alberto Renato De Angelis, San Donato Milanese (IT); Giovanni Regattieri, Ravenna (IT); Chiara Carrozza, Pesaro (IT)

(21) Appl. No.: 17/053,114

(22) PCT Filed: May 10, 2019
(86) PCT No.: PCT/EP2019/062025

§ 371 Date: Nov. 5, 2020

(30) Foreign Application Priority Data
May 11, 2018 (IT) 102018000005265

(51) Int. Cl. C08G 75/14

(52) U.S. Cl. CPC C08G 75/14

(57) ABSTRACT

Elastomeric terpolymer with a high sulfur content comprising:—sulfur in a quantity higher than or equal to 40% by weight, preferably ranging from 55% by weight to 90% by weight, with respect to the total weight of said elastomeric terpolymer;—a first monomer selected from aromatic vinyl compounds, preferably from styrene, divinylbenzene, vinyl toluene, tert-butylstyrene, p-methylstyrene, γ-methylstyrene, α-methylstyrene, vinylnaphthalene;—a second monomer selected from:—aromatic vinyl compounds, preferably from styrene, divinylbenzene, vinyl toluene, tert-butylstyrene, p-methylstyrene, γ-methylstyrene, α-methylstyrene, vinyl-naphthalene;—monomers having general formula (I): CH₂═CH—(CH₂)_{y}—(X)ₙ—(X)ₘ—(CH₂)ₓ—CH═CH₂, wherein:—X represents a sulfur atom, a selenium atom, a tellurium atom, preferably a sulfur atom, a selenium atom;—y and x, equal to or different from one another, are a whole number ranging from 0 to 4;—n and m, equal to or different from one another, are a whole number ranging from 0 to 3, at least one of n and m being equal to 1; said first monomer and said second monomer being present in a quantity lower than or equal to 60% by weight, preferably ranging from 10% by weight to 45% by weight, with respect to the total weight of said elastomeric terpolymer; said first monomer and said second monomer being different from one another. Said elastomeric terpolymer with a high sulfur content may be advantageously used in various applications such as, for example, thermal insulation, conveyor belts, transmission belts, flexible hoses and, in particular, in elastomeric compositions for tyres.

The present invention relates to an elastomeric terpolymer with a high sulfur content.

More particularly, the present invention relates to an elastomeric terpolymer with a high sulfur content comprising: sulfur in a quantity higher than or equal to 40% by weight, preferably ranging from 55% by weight to 90% by weight, with respect to the total weight of said elastomeric terpolymer; a first monomer selected from aromatic vinyl compounds; a second monomer selected from aromatic vinyl compounds or from allyl chalcogenides; said first monomer and said second monomer being present in a quantity lower than or equal to 60% by weight, preferably ranging from 10% by weight to 45% by weight, with respect to the total weight of said elastomeric terpolymer; said first monomer and said second monomer being different from one another.

The present invention also relates to a process for the preparation of said elastomeric terpolymer with a high sulfur content.

Said elastomeric terpolymer with a high sulfur content may be advantageously used in various applications such as, for example, thermal insulation, conveyor belts, transmission belts, flexible hoses and, in particular, in elastomeric compositions for tyres.

It is well known that in the oil industry, during the production of natural gas and oil, increasingly large quantities of elemental sulfur are produced, the production surplus of which currently exceeds one million tonnes per year, with a tendency to further increase as new fields are developed in which the content of hydrogen sulfide (H₂S) and of elemental sulfur will become more and more significant. The world production surplus of sulfur not only causes a depression in the market price thereof, so that transport costs may have a negative impact on its marketing, but also causes significant environmental problems due to the storage of large quantities of elemental sulfur. In fact, if the storage is performed in the open air or underground, the aggression of atmospheric agents may cause the contamination of the surrounding areas. In this regard, it is worth mentioning, for example, the phenomenon known as “dusting” or dispersion of sulfur powder which, in turn, through oxidation may produce acidic substances (for example, sulfuric acid).

Studies have been carried out with the aim of using elemental sulfur for the preparation of copolymers with a high sulfur content.

For example, US patent application 2014/0199592 describes a polymeric composition comprising a sulfur copolymer, in a quantity of at least about 50% by weight with respect to the copolymer, and one or more monomers selected from the group consisting of ethylenically unsaturated monomers, epoxy monomers, thiirane monomers, in a quantity ranging from about 0.1% by weight and about 50% by weight with respect to the copolymer. The above mentioned polymeric composition with a high sulfur content is said to be advantageously usable in electrochemical cells and optical elements.

Khaway S. Z. et al., in “Material Letters” (2017), Vol. 203, pages 58-61, describe the preparation of flexible copolymers with a high sulfur content obtained through the reverse vulcanization technique by reacting sulfur and diallyl disulfide. The above mentioned copolymers are said to have good transparency, high flexibility due to their low glass transition temperature (T_{g}), a very low Young modulus and a high tensile strain at break. In addition, the above mentioned copolymers are said to be advantageously usable as thermal insulators or as optical materials transparent to infrared light.

However, also in the case of flexible copolymers, high elongation at break values are not always obtained, said elongation at break values being of particular interest in view of their use in elastomeric compositions for tyres.

The Applicant therefore posed the problem of finding new elastomeric terpolymers with a high sulfur content having low glass transition temperatures (T_{g}) [i.e. glass transition temperatures (T_{g}) lower than or equal to +1° C.] and good elastic properties, in particular in terms of elongation at break [i.e. elongation at break values higher than or equal to 500%].

The Applicant has now found elastomeric terpolymers with a high sulfur content comprising: sulfur in a quantity higher than or equal to 40% by weight, preferably ranging from 55% by weight to 90% by weight, with respect to the total weight of said elastomeric terpolymer; a first monomer selected from aromatic vinyl compounds; a second monomer selected from aromatic vinyl compounds or from allyl chalcogenides; said first monomer and said second monomer being present in a quantity lower than or equal to 60% by weight, preferably ranging from 10% by weight to 45% by weight, with respect to the total weight of said elastomeric terpolymer; said first monomer and said second monomer being different from one another; having low glass transition temperatures (T_{g}) [i.e. glass transition temperatures (T_{g}) lower than or equal to +1° C.] and good elastic properties, in particular in terms of elongation at break [i.e. elongation at break values higher than or equal to 500%]. Said elastomeric terpolymers with high sulfur content, thanks to their features, may be advantageously used in various applications such as, for example, thermal insulation, conveyor belts, transmission belts, flexible hoses and, in particular, in elastomeric compositions for tyres.

The subject of the present invention is therefore an elastomeric terpolymer with a high sulfur content comprising:

sulfur in a quantity higher than or equal to 40% by weight, preferably ranging from 55% by weight to 90% by weight, with respect to the total weight of said elastomeric terpolymer;

a first monomer selected from aromatic vinyl compounds, preferably from styrene, divinylbenzene, vinyl toluene, tert-butylstyrene, p-methylstyrene, γ-methylstyrene, α-methylstyrene, vinylnaphthalene;

a second monomer selected from:
aromatic vinyl compounds, preferably from styrene, divinylbenzene, vinyl toluene, tert-butylstyrene, p-methylstyrene, γ-methylstyrene, α-methylstyrene, vinylnaphthalene;
monomers having general formula (I):

CH₂═CH—(CH₂)_{y}—(X)ₙ—(X)ₘ—(CH₂)ₓ—CH═CH₂ (I)
wherein:
   X represents a sulfur atom, a selenium atom, a tellurium atom, preferably a sulfur atom, a selenium atom;
   y and x, equal to or different from one another, are a whole number ranging from 0 to 4;
   n and m, equal to or different from one another, are a whole number ranging from 0 to 3, at least one of n and m being equal to 1;

said first monomer and said second monomer being present in a quantity lower than or equal to 60% by weight, preferably ranging from 10% by weight to 45% by weight, with respect to the total weight of said elastomeric terpolymer; said first monomer and said second monomer being different from one another.

For the purpose of the present description and of the following claims, the definitions of the numerical ranges always comprise the extremes unless otherwise specified.

For the purpose of the present description and of the following claims, the term “comprising” also includes the terms “which essentially consists of” or “which consists of”.

According to a preferred embodiment of the present invention, said first monomer may be selected, for example, from styrene, divinylbenzene.

According to a preferred embodiment of the present invention, said second monomer may be selected, for example, from styrene, divinylbenzene, allyl disulfide, diallyl disulfide, diallyl trisulfide, divinyl disulfide.

According to a preferred embodiment of the present invention, said elastomeric terpolymer with a high sulfur content comprises:

sulfur in a quantity equal to 60% by weight with respect to the total weight of said elastomeric terpolymer;

styrene in a quantity equal to 30% by weight with respect to the total weight of said elastomeric terpolymer;

allyl disulfide in a quantity equal to 10% by weight with respect to the total weight of said elastomeric terpolymer.

According to a further preferred embodiment of the present invention, said elastomeric terpolymer with a high sulfur content comprises:

sulfur in a quantity equal to 60% by weight with respect to the total weight of said elastomeric terpolymer;

styrene in a quantity equal to 10% by weight with respect to the total weight of said elastomeric terpolymer;

divinylbenzene in a quantity equal to 30% by weight with respect to the total weight of said elastomeric terpolymer.

According to a preferred embodiment of the present invention, said elastomeric terpolymer with a high sulfur content may have a glass transition temperature (T_{g}) lower than or equal to +1° C.

Said glass transition temperature (T_{g}) was determined by DSC (Differential Scanning calorimetry) thermal analysis, which was carried out as described in the paragraph “Analysis and characterisation methods” below reported.

According to a preferred embodiment of the present invention, said elastomeric terpolymer with a high sulfur content may have an elongation at break higher than or equal to 500%.

Said elongation at break was determined according to the standard ISO 37:2017.

As mentioned above, the present invention also relates to a process for the preparation of said elastomeric terpolymer with a high sulfur content.

Consequently, a further subject of the present invention is a process for the preparation of an elastomeric terpolymer with a high sulfur content comprising:

(i) melting the sulfur at a temperature ranging from 110° C. to 190° C., preferably ranging from 120° C. to 170° C., for a time ranging from 1 minute to 15 minutes, preferably ranging from 2 minutes to 10 minutes, obtaining sulfur in liquid form;
(ii) reacting the sulphur in liquid form obtained in stage (i) with a first monomer selected from aromatic vinyl compounds, preferably from styrene, divinylbenzene, vinyl toluene, tert-butylstyrene, p-methylstyrene, γ-methylstyrene, α-methylstyrene, vinylnaphthalene, at a temperature ranging from 110° C. to 190° C., preferably ranging from 120° C. to 170° C., for a time ranging from 1 minute to 15 minutes, preferably ranging from 2 minutes to 10 minutes and, subsequently adding a second monomer selected from aromatic vinyl compounds, preferably from styrene, divinylbenzene, vinyl toluene, tert-butylstyrene, p-methylstyrene, γ-methylstyrene, α-methylstyrene, vinylnaphthalene, or from monomers having general formula (I), preferably from allyl disulfide, diallyl disulfide, diallyl trisulfide, divinyl disulfide, said first monomer and said second monomer being different from one another, at a temperature ranging from 110° C. to 190° C., preferably ranging from 120° C. to 170° C., for a time ranging from 1 minute to 15 minutes, preferably ranging from 2 minutes to 10 minutes, obtaining a liquid pre-polymer;
(iii) pouring the liquid pre-polymer obtained in stage (ii) into a mould and maintaining said mould at a temperature ranging from 100° C. to 150° C., preferably ranging from 110° C. to 130° C., for a time ranging from 1 hour to 20 hours, preferably ranging from 2 hours to 15 hours, obtaining an elastomeric terpolymer with a high sulfur content.

According to a preferred embodiment of the present invention, the sulfur used in said stage (i) is elemental sulfur.

For the purpose of the process that is the subject of the present invention, said elemental sulfur is preferably in powder form. Under ambient conditions (i.e. at ambient temperature and pressure), the elemental sulfur exists in orthorhombic crystalline form (eight-sided ring) (S₈) and has a melting temperature ranging from 120° C. to 124° C. Said elemental sulfur in orthorhombic crystalline form (S₈), at a temperature above 159° C., is subject to ring opening polymerization (ROP) and is transformed into a linear polymer chain with two free radicals at the ends. Said linear polymer chain is metastable and therefore tends, more or less slowly depending on the conditions, to revert into the orthorhombic crystalline form (S₈).

For the purpose of the process that is the subject of the present invention, said elemental sulfur is in orthorhombic crystalline form (S₈), said form being, generally, the most stable, the most accessible and the least expensive. However, it should be noted that, for the purpose of the present invention, the other allotropic forms of sulfur may also be used, such as, for example, cyclic allotropic forms resulting from thermal processes to which elemental sulfur may be subjected in an orthorhombic crystalline form (S₈). It should also be noted that any species of sulfur which, when heated, makes it possible to obtain species capable of undergoing radical or anionic polymerization, may be used for the purpose of the process which is the subject of the present invention.

As mentioned above, said elastomeric terpolymer with a high sulfur content may be advantageously used in various applications such as, for example, thermal insulation, conveyor belts, transmission belts, flexible hoses, elastomeric compositions for tyres.

Consequently, a further subject of the present invention is the use of said elastomeric terpolymer with a high sulfur content in various applications such as, for example, thermal insulation, conveyor belts, transmission belts, flexible hoses and, in particular, in elastomeric compositions for tyres.

In order to better understand the present invention and to put it into practice, the following are some illustrative and non-limiting examples thereof.

### EXAMPLES

### Analysis and Characterization Methods

The analysis and characterization methods below reported have been used.

### Thermal Analysis (DSC)

The DSC (Differential Scanning calorimetry) thermal analysis, for the purpose of determining the glass transition temperature (T_{g}) of the elastomeric terpolymers obtained, was carried out by means of a Perkin Elmer Pyris differential scanning calorimeter, using the following thermal programme:

cooling from ambient temperature (T=25° C.) to −60° C. at a rate of −5° C./minute;

heating from −60° C. to +150° C. at a rate of +10° C./minute (first scan);

cooling from +150° C. to −60° C. at a rate of −5° C./minute;

heating from −60° C. to +150° C. at a rate of +10° C./minute (second scan); working under a nitrogen (N₂) stream at 70 ml/minute.

### Example 1 (Invention)

### Synthesis of Elastomeric Terpolymer With Sulfur (60% by Weight), Styrene (30% by Weight) and Allyl Disulfide (10% by Weight)

6 g of pure sulfur [elemental sulfur in orthorhombic crystalline form (S₈) of Sigma-Aldrich] were charged into a 60 ml glass autoclave equipped with a magnetic stirrer: the autoclave was heated to 160° C. and maintained at said temperature for 10 minutes, obtaining the melting of the sulfur, which becomes a yellow liquid. 3 g of liquid styrene (Sigma-Aldrich) was then added, drop by drop, to said liquid: the whole was maintained, under stirring, at 160° C. for 3 minutes, obtaining a solution. 1 g of liquid allyl disulfide (Sigma-Aldrich) was then added, drop by drop, to said solution: the whole was maintained, under stirring, at 160° C. for a further 3 minutes, obtaining a solution which remains still fluid and takes on an intense red colour. The fluid solution thus obtained was poured into a Teflon mould that was closed and heated to 120° C. in an oven: said fluid solution was maintained at said temperature for 12 hours, obtaining an elastomeric terpolymer black in colour and with a translucent appearance.

Said elastomeric terpolymer was subjected to DSC (Differential Scanning calorimetry) thermal analysis, operating as described above, in order to measure the glass transition temperature (T_{g}) which was found to be equal to −0.3° C.

Said elastomeric terpolymer was also subjected to elongation at break, determined according to the standard ISO 37:2017, which was found to be equal to 520%.

### Example 2 (Invention)

### Synthesis of Elastomeric Terpolymer With Sulfur (60% by Weight), Styrene (10% by Weight) and Divinylbenzene (30% by Weight)

6 g of pure sulfur [elemental sulfur in orthorhombic crystalline form (S₈) of Sigma-Aldrich] was charged into a 60 ml glass autoclave equipped with a magnetic stirrer: the autoclave was heated to 160° C. and maintained at said temperature for 10 minutes, obtaining the melting of the sulfur, which becomes a yellow liquid. 1 g of liquid styrene (Sigma-Aldrich) was then added, drop by drop, to said liquid: the whole was maintained, under stirring, at 160° C., for 3 minutes, obtaining a solution. 3 g of liquid divinylbenzene (Sigma-Aldrich) was then added, drop by drop, to said solution: the whole was maintained, under stirring, at 160° C., for a further 3 minutes, obtaining a solution which remains still fluid and takes on an intense red colour. The fluid solution thus obtained was poured into a Teflon mould that was closed and heated to 120° C. in an oven: said fluid solution was maintained at said temperature for 12 hours, obtaining an elastomeric terpolymer black in colour and with a translucent appearance.

Said elastomeric terpolymer was subjected to DSC (Differential Scanning calorimetry) thermal analysis, operating as described above, for the purpose of measuring the glass transition temperature (T_{g}), which was found to be equal to +0.96° C.

Said elastomeric terpolymer was also subjected to elongation at break, determined according to the standard ISO 37:2017, which was found to be equal to 630%.

### Example 3 (Comparative)

### Synthesis of Elastomeric Copolymer With Sulfur (70% by Weight) and Diallyl Disulfide (30% by Weight)

7 g of pure sulfur [elemental sulfur in orthorhombic crystalline form (S₈) of Sigma-Aldrich] was charged into a 60 ml glass autoclave equipped with a magnetic stirrer: the autoclave was heated to 160° C. and maintained at said temperature for 10 minutes, obtaining the melting of the sulfur, which becomes a yellow liquid. 3 g of liquid diallyl disulfide (Sigma-Aldrich) was then added, drop by drop, to said liquid: the whole was maintained, under stirring, at 160° C. for 3 minutes, obtaining a solution which remains still fluid and takes on an intense red colour. The fluid solution thus obtained was poured into a Teflon mould that was closed and heated to 120° C. in an oven: said fluid solution was maintained at said temperature for 12 hours, obtaining an elastomeric copolymer black in colour and with a translucent appearance.

Said elastomeric copolymer was subjected to DSC (Differential Scanning calorimetry) thermal analysis, operating as described above, for the purpose of measuring the glass transition temperature (T_{g}), which was found to be equal to −15° C.

Said elastomeric copolymer was also subjected to elongation at break, determined according to the standard ISO 37:2017, which was found to be equal to 56%.

1. Elastomeric terpolymer with a high sulfur content comprising:
sulfur in a quantity higher than or equal to 40% by weight with respect to the total weight of said elastomeric terpolymer;
a first monomer selected from an aromatic vinyl compound and
a second monomer selected from:
an aromatic vinyl compound and;
a monomer having general formula (I):
CH₂═CH—(CH₂)_{y}—(X)ₙ—(X)ₘ—(CH₂)ₓ—CH═CH₂ (I)
wherein:
X represents a sulfur atom, a selenium atom, or a tellurium atom;
y and x, equal to or different from one another, are a whole number ranging from 0 to 4; and
n and m, equal to or different from one another, are a whole number ranging from 0 to 3, at least one of n and m being equal to 1;
wherein said first monomer and said second monomer are present in a quantity lower than or equal to 60% by weight with respect to the total weight of said elastomeric terpolymer; and wherein said first monomer and said second monomer are different from one another.

2. Elastomeric terpolymer with a high sulfur content according to claim 1, wherein said first monomer is selected from the group consisting of styrene and divinylbenzene.

3. Elastomeric terpolymer with a high sulfur content according to claim 1, wherein said second monomer is selected from the group consisting of styrene, divinylbenzene, allyl disulfide, diallyl disulfide, diallyl trisulfide, and divinyl disulfide.

4. Elastomeric terpolymer with a high sulfur content according to claim 1, wherein said elastomeric terpolymer with a high sulfur content comprises:
sulfur in a quantity equal to 60% by weight with respect to the total weight of said elastomeric terpolymer;
styrene in a quantity equal to 30% by weight with respect to the total weight of said elastomeric terpolymer; and
allyl disulfide in a quantity equal to 10% by weight with respect to the total weight of said elastomeric terpolymer.

5. Elastomeric terpolymer with a high sulfur content according to claim 1, wherein said elastomeric terpolymer with a high sulfur content comprises:
sulfur in a quantity equal to 60% by weight with respect to the total weight of said elastomeric terpolymer;
styrene in a quantity equal to 10% by weight with respect to the total weight of said elastomeric terpolymer; and
divinylbenzene in a quantity equal to 30% by weight with respect to the total weight of said elastomeric terpolymer.

6. Elastomeric terpolymer with a high sulfur content according to claim 1, wherein said elastomeric terpolymer with a high sulfur content has a glass transition temperature (T_{g}) lower than or equal to +1° C.

7. Elastomeric terpolymer with a high sulfur content according to claim 1, wherein said elastomeric terpolymer with a high sulfur content has an elongation at break higher than or equal to 500%.

8. Process for the preparation of an elastomeric terpolymer with a high sulfur content comprising:
(i) melting the sulfur at a temperature ranging from 110° C. to 190° C. for a time ranging from 1 minute to 15 minutes obtaining sulfur in liquid form;
(ii) reacting the sulfur in liquid form obtained in stage (i) with a first monomer of an aromatic vinyl compound at a temperature ranging from 110° C. to 190° C. for a time ranging from 1 minute to 15 minutes and subsequently adding a second monomer of an aromatic vinyl compound or from monomers having general formula (I) at a temperature ranging from 110° C. to 190° C. for a time ranging from 1 minute to 15 minutes obtaining a liquid pre-polymer, wherein said first monomer and said second monomer are different from one another;
(iii) pouring the liquid pre-polymer obtained in stage (ii) into a mould and maintaining said mould at a temperature ranging from 100° C. to 150° C. for a time ranging from 1 hour to 20 hours obtaining an elastomeric terpolymer with a high sulfur content.

9. Process for the preparation of an elastomeric terpolymer with a high sulfur content according to claim 8, wherein the sulfur used in said stage (i) is elemental sulfur.

10. A method, comprising incorporating the Use of art elastomeric terpolymer with a high sulfur content according to claim 1, in thermal insulation, a conveyor belt, a transmission belt, a flexible hose or a tyre.

11. Elastomeric terpolymer with a high sulfur content according to claim 1, wherein the sulfur is present in a quantity ranging from 55% by weight to 90% by weight with respect to the total weight of said elastomeric terpolymer.

12. Elastomeric terpolymer with a high sulfur content according to claim 1, wherein said first monomer is an aromatic vinyl compound selected from the group consisting of styrene, divinylbenzene, vinyl toluene, tert-butylstyrene, p-methylstyrene, γ-methylstyrene, γ-methylstyrene and vinylnaphthalene.

13. Elastomeric terpolymer with a high sulfur content according to claim 1, wherein said second monomer is an aromatic vinyl compound selected from the group consisting of styrene, divinylbenzene, vinyl toluene, tert-butylstyrene, p-methylstyrene, γ-methylstyrene, α-methylstyrene and vinylnaphthalene.

14. Elastomeric terpolymer with a high sulfur content according to claim 1, wherein said first monomer and said second monomer are being present in a quantity ranging from 10% to 45% by weight with respect to the total weight of said elastomeric terpolymer.

15. Process for the preparation of an elastomeric terpolymer with a high sulfur content according to claim 8, wherein the sulfur is melted at a temperature ranging from 120° C. to 170° C. for a time ranging from 2 minutes to 10 minutes.

16. Process for the preparation of an elastomeric terpolymer with a high sulfur content according to claim 8, wherein said first monomer is an aromatic vinyl compound selected from the group consisting of styrene, divinylbenzene, vinyl toluene, tert-butylstyrene, p-methylstyrene, γ-methylstyrene, α-methylstyrene and vinylnaphthalene.

17. Process for the preparation of an elastomeric terpolymer with a high sulfur content according to claim 8, wherein said second monomer is an aromatic vinyl compound selected from the group consisting of styrene, divinylbenzene, vinyl toluene, tert-butylstyrene, p-methylstyrene, γ-methylstyrene, α-methylstyrene and vinylnaphthalene.

18. Process for the preparation of an elastomeric terpolymer with a high sulfur content according to claim 8, wherein the sulfur is reacted at a temperature ranging from 120° C. to 170° C. for a time ranging from 2 minutes to 10 minutes.

19. Process for the preparation of an elastomeric terpolymer with a high sulfur content according to claim 8, wherein the monomer having general formula (I) is selected from the group consisting of allyl disulfide, diallyl disulfide, diallyl trisulfide and divinyl disulfide.

20. Process for the preparation of an elastomeric terpolymer with a high sulfur content according to claim 8, wherein the liquid pre-polymer is poured a mould and maintained at a temperature ranging from 110° C. to 130° C. for a time ranging from 2 hours to 15 hours.
